(19) United States
(12) Patent Application Publication
(10) Pub. No.: US 2015/0207171 A1
(43) Pub. Date: Jul. 23, 2015

(54) THIN FILM ELECTROLYTE BASED 3D MICRO-BATTERIES

(71) Applicant: The Regents of the University of California, Oakland, CA (US)

(72) Inventors: Jane P. Chang, Los Angeles, CA (US); Bruce S. Dunn, Los Angeles, CA (US); Ya-Chuan Perng, Rowland Heights, CA (US); Jea Cho, Los Angeles, CA (US); Chang-Jin Kim, Beverly Hills, CA (US); Sarah Helen Tolbert, Los Angeles, CA (US); Robert James Thompson, Los Angeles, CA (US)

(21) Appl. No.: 14/421,971

(22) PCT Filed: Aug. 16, 2013
(86) PCT No.: PCT/US13/55376

§ 371 Date: Feb. 16, 2015

Related U.S. Application Data
(60) Provisional application No. 61/683,952, filed on Aug. 16, 2012.

(51) Int. Cl. H01M 10/0562; H01M 10/0565; H01M 10/058; H01M 10/0568

(52) U.S. Cl. CPC H01M 10/0562; H01M 10/0568; H01M 10/0565; H01M 10/058; H01M 2220/30

(57) ABSTRACT

Embodiments of a 3D micro-battery structure are disclosed. The 3D micro-battery structure includes an electrode micro-structure and a thin film electrolyte. The electrode micro-structure includes a base and a group of electrodes extending from the base. The thin film electrolyte conformally coats each of the group of electrodes to form a group of coated electrodes, such that the thin film electrolyte is ionically conducting and is electrically insulating.

### RELATED APPLICATION

This application claims the benefit of U.S. provisional patent application No. 61/683,952, filed Aug. 16, 2012, the disclosure of which is hereby incorporated herein by reference in its entirety.

### GOVERNMENT SUPPORT

This invention was made with government support under Grant No. N66001-10-1-4007 awarded by the Defense Advanced Research Project Agency; Grant No. 0932761, awarded by the National Science Foundation. The Government has certain rights in this invention.

### FIELD OF THE DISCLOSURE

Embodiments of the present disclosure relate to 3D micro-batteries and 3D micro-battery structures, which may be used to power portable electronic devices.

### BACKGROUND

The demand for portable electronic devices has grown rapidly over the last few decades. As such, increasing capabilities and minimizing size, weight, and cost have been part of the ongoing development of such devices. Since batteries are typically used to power most portable electronic devices, and since batteries tend to contribute significantly to size, weight, and cost, there is a need to reduce the size, weight, and cost of batteries, and to provide battery support for the increased capabilities of the portable electronic devices. Improvements in gravimetric energy density, volumetric energy density, and robustness in packaging may significantly reduce battery size, weight, and cost, while supporting the increased capabilities of the portable electronic devices. Therefore, there is a need for batteries that provide increased gravimetric energy density, volumetric energy density, and robustness in packaging.

### SUMMARY

Embodiments of a 3D micro-battery structure are disclosed. The 3D micro-battery structure includes a 3D electrode micro-structure and a thin film electrolyte. The 3D electrode micro-structure includes a base and a group of electrodes extending from the base. The thin film electrolyte conformally coats each of the group of electrodes to form a group of coated electrodes, such that the thin film electrolyte is ionically conducting and is electrically insulating.

In one embodiment of the 3D micro-battery structure, the 3D micro-battery structure further includes a counter electrode micro-structure, such that the 3D electrode micro-structure functions as one battery terminal and the counter electrode micro-structure functions as an opposite battery terminal. The counter electrode micro-structure substantially fills spaces in the 3D electrode micro-structure and is in contact with the group of coated electrodes. As such, the group of coated electrodes may collectively have a large surface area to increase ion conduction between the 3D electrode micro-structure and the counter electrode micro-structure, thereby reducing an internal battery resistance of the 3D micro-battery structure. Additionally, by using a thin film conformally coating electrolyte, physical sizes of the 3D electrode micro-structure and the counter electrode micro-structure may be reduced and lengths of ion conduction paths may be reduced, thereby further reducing the internal battery resistance of the 3D micro-battery structure and reducing the physical size of the 3D micro-battery structure. As such, gravimetric energy density, volumetric energy density, and robustness in packaging may all be increased.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 shows details of a 3D electrode micro-structure according to one embodiment of the 3D electrode micro-structure.

FIG. 2 shows details of a 3D micro-battery structure according to one embodiment of the 3D micro-battery structure.

FIG. 3 shows details of the 3D micro-battery structure according to an alternate embodiment of the 3D micro-battery structure.

FIG. 4 shows details of the 3D micro-battery structure according to an additional embodiment of the 3D micro-battery structure.

FIG. 5 shows details of the 3D micro-battery structure according to another embodiment of the 3D micro-battery structure.

FIG. 6 shows details of the 3D micro-battery structure according to a further embodiment of the 3D micro-battery structure.

FIG. 7 illustrates a process for forming the 3D micro-battery structure illustrated in FIG. 2 according to one embodiment of the 3D micro-battery structure.

FIG. 8 illustrates a process for forming the 3D micro-battery structure 16 illustrated in FIG. 2 according to another embodiment of the 3D micro-battery structure.

FIG. 9 illustrates surface grafting a conformal thin film polymer electrolyte on a surface of the group of electrodes illustrated in FIG. 1 according to one embodiment of the present disclosure.

FIG. 10 shows three graphs illustrating X-Ray photoelectron spectroscopy Carbon core loss peaks of a Silicon wafer.

FIG. 11 shows three graphs illustrating X-Ray photoelectron spectroscopy Nitrogen core loss peaks of a Silicon wafer.

FIG. 12 shows three graphs illustrating X-Ray photoelectron spectroscopy Chlorine core loss peaks of a Silicon wafer.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

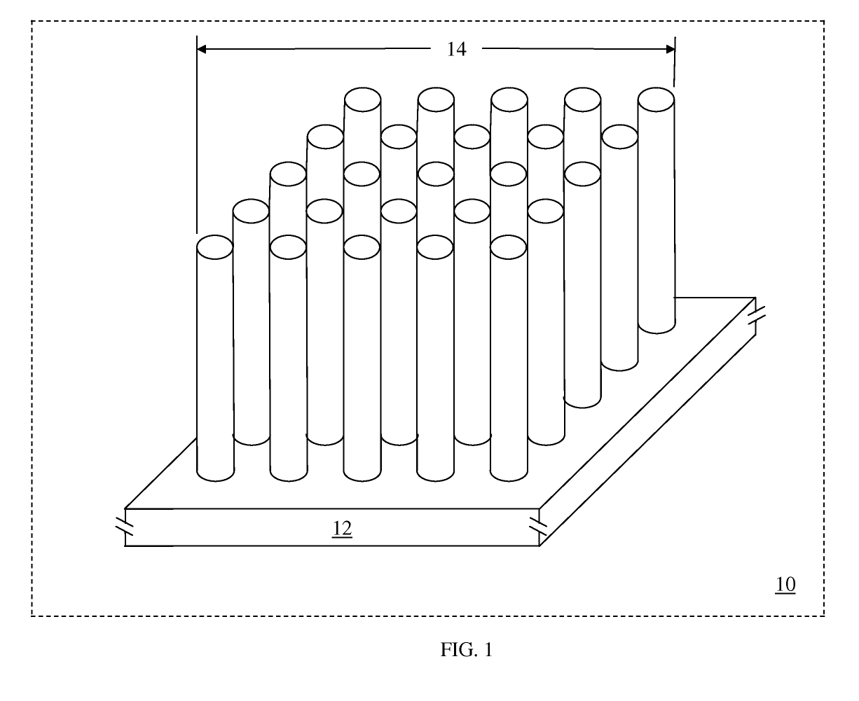

FIG. 1 shows details of a 3D electrode micro-structure 10 according to one embodiment of the 3D electrode micro-structure 10. The 3D electrode micro-structure 10 includes a base 12 and a group 14 of electrodes extending from the base 12. The group 14 of electrodes illustrated in FIG. 1 is shown as a 3D arrangement of high aspect ratio rods. However, in alternate embodiments of the 3D electrode micro-structure 10, the group 14 of electrodes may be a 3D arrangement of plates, ridges, nanowires, deeply etched trenches, tubes, blocks, pyramids, cylinders, nano-structures, the like, or any combination thereof. In one embodiment of the group 14 of electrodes, since 2D structures may include planar geometries and since the group 14 of electrodes forms a 3D structure, the group 14 of electrodes has a group of non-planar geometries.

In a first embodiment of the group 14 of electrodes, a length of each of the group 14 of electrodes is less than about 10 nanometers. In a second embodiment of the group 14 of electrodes, a length of each of the group 14 of electrodes is less than about 100 nanometers. In a third embodiment of the group 14 of electrodes, a length of each of the group 14 of electrodes is less than about one micrometer. In a fourth embodiment of the group 14 of electrodes, a length of each of the group 14 of electrodes is less than about 10 micrometers. In a fifth embodiment of the group 14 of electrodes, a length of each of the group 14 of electrodes is less than about 100 micrometers. In a sixth embodiment of the group 14 of electrodes, a length of each of the group 14 of electrodes is less than about one millimeter. In a seventh embodiment of the group 14 of electrodes, a length of each of the group 14 of electrodes is less than about 10 millimeters. In an eighth embodiment of the group 14 of electrodes, a length of each of the group 14 of electrodes is less than about 100 millimeters.

In a first embodiment of the 3D electrode micro-structure 10, the 3D electrode micro-structure 10 includes Carbon. In a second embodiment of the 3D electrode micro-structure 10, the 3D electrode micro-structure 10 includes Silicon. In a third embodiment of the 3D electrode micro-structure 10, the 3D electrode micro-structure 10 includes Tin. In a fourth embodiment of the 3D electrode micro-structure 10, the 3D electrode micro-structure 10 includes Lithium. In a fifth embodiment of the 3D electrode micro-structure 10, the 3D electrode micro-structure 10 includes Titanium.

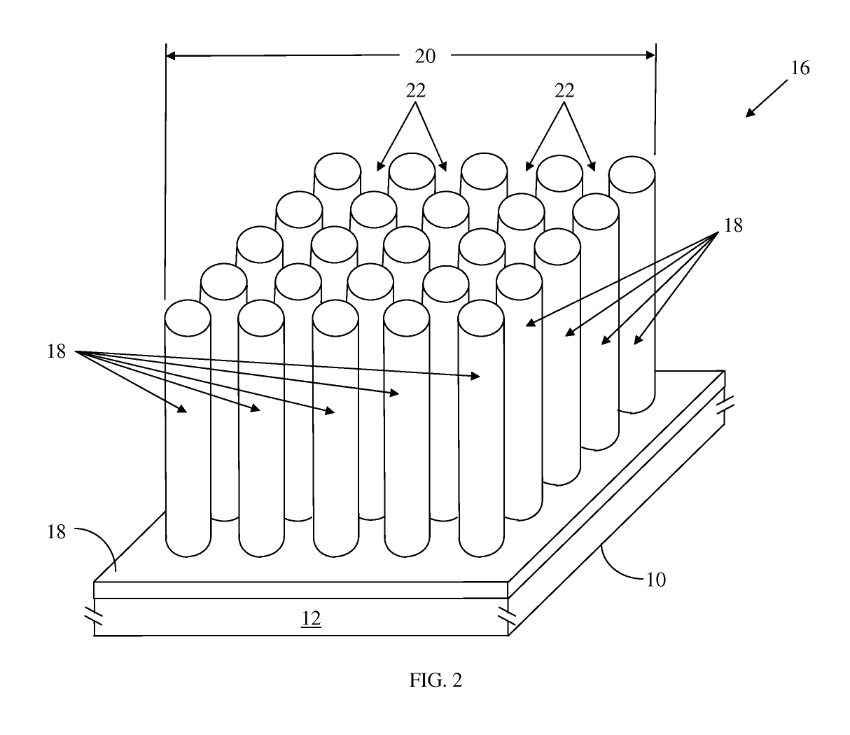

FIG. 2 shows details of a 3D micro-battery structure 16 according to one embodiment of the 3D micro-battery structure 16. The 3D micro-battery structure 16 includes the 3D electrode micro-structure 10 and a thin film electrolyte 18. The thin film electrolyte 18 conformally coats each of the group 14 (FIG. 1) of electrodes to form a group 20 of coated electrodes. Further, the thin film electrolyte 18 is on a surface of the base 12 from which the group 20 of coated electrodes extends. In an alternate embodiment of the 3D micro-battery structure 16, the thin film electrolyte 18 is not on any surface of the base 12. In an additional embodiment of the 3D micro-battery structure 16, the thin film electrolyte 18 is partially on any surface of the base 12.

In a first embodiment of the group 20 of coated electrodes, the thin film electrolyte 18 does not provide complete coverage of the group 20 of coated electrodes, but provides at least 99% coverage. In a second embodiment of the group 20 of coated electrodes, the thin film electrolyte 18 does not provide complete coverage of the group 20 of coated electrodes, but provides at least 95% coverage. In a third embodiment of the group 20 of coated electrodes, the thin film electrolyte 18 does not provide complete coverage of the group 20 of coated electrodes, but provides at least 90% coverage. In a fourth embodiment of the group 20 of coated electrodes, the thin film electrolyte 18 does not provide complete coverage of the group 20 of coated electrodes, but provides at least 85% coverage.

The thin film electrolyte 18 is ionically conducting and is electrically insulating. In one embodiment of the thin film electrolyte 18, the thin film electrolyte 18 includes inorganic material. In one embodiment of the thin film electrolyte 18, the thin film electrolyte 18 includes organic material. In one embodiment of the thin film electrolyte 18, the thin film electrolyte 18 is an atomic layer deposited thin film. There are spaces 22 among the group 20 of coated electrodes. As such, due to the spaces 22, the group 20 of coated electrodes may collectively have a large surface area to readily facilitate ion conduction. A larger surface area may reduce an internal battery resistance of the 3D micro-battery structure 16.

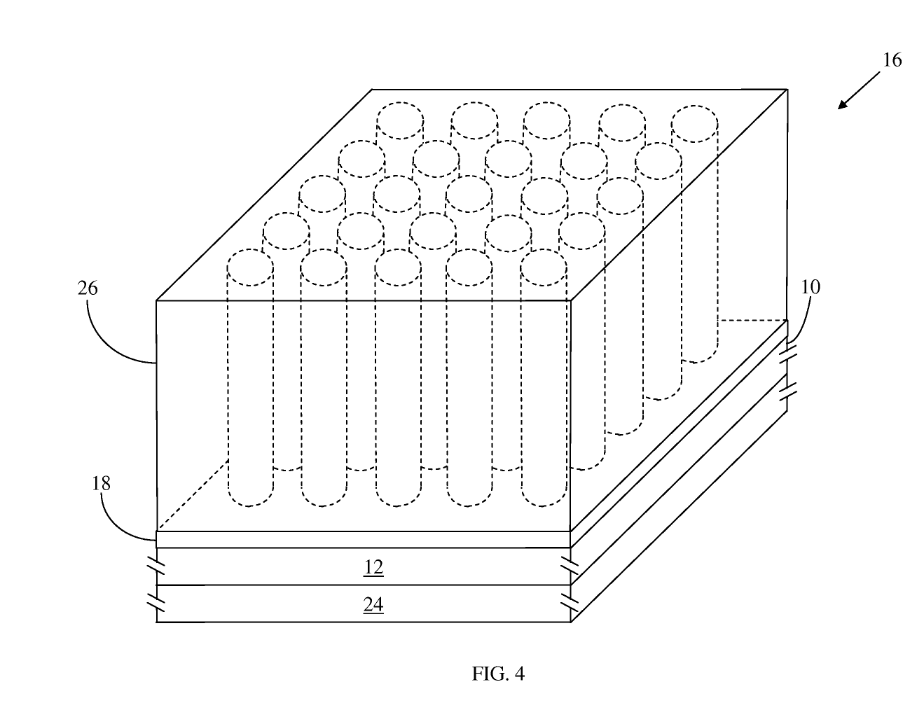

In one embodiment of the thin film electrolyte 18, the thin film electrolyte 18 is ionically conducting over an operating temperature range of the 3D micro-battery structure 16. In one embodiment of the thin film electrolyte 18, the thin film electrolyte 18 is electrically insulating over the operating temperature range of the 3D micro-battery structure 16. In one embodiment of the thin film electrolyte 18, the thin film electrolyte 18 is stable against chemical reactions with the 3D electrode micro-structure 10. In one embodiment of the thin film electrolyte 18, the thin film electrolyte 18 is stable against chemical reactions with a counter electrode micro-structure 26 (FIG. 4). In one embodiment of the thin film electrolyte 18, a temperature coefficient of expansion of the thin film electrolyte 18 is about equal to a temperature coefficient of expansion of the 3D electrode micro-structure 10. In one embodiment of the thin film electrolyte 18, the temperature coefficient of expansion of the thin film electrolyte 18 is about equal to a temperature coefficient of expansion of the counter electrode micro-structure 26 (FIG. 4).

Ionic conductivity σ is a measure of conductivity in the thin film electrolyte 18 via ionic charge carriers. The units of ionic conductivity are typically Siemens per centimeter (S/cm). In one embodiment of the thin film electrolyte 18. In a first embodiment of the thin film electrolyte 18, the ionic conductivity of the thin film electrolyte 18 is between about 10⁻¹ and about 10⁻⁵ S/cm. In a second embodiment of the thin film electrolyte 18, the ionic conductivity of the thin film electrolyte 18 is between about 10⁻² and about 10⁻⁶ S/cm. In a third embodiment of the thin film electrolyte 18, the ionic conductivity of the thin film electrolyte 18 is between about 10⁻³ and about 10⁻⁷ S/cm. In a fourth embodiment of the thin film electrolyte 18, the ionic conductivity of the thin film electrolyte 18 is between about 10⁻⁴ and about 10⁻⁸ S/cm. In a fifth embodiment of the thin film electrolyte 18, the ionic conductivity of the thin film electrolyte 18 is between about 10⁻⁵ and about 10⁻⁹ S/cm. In a sixth embodiment of the thin film electrolyte 18, the ionic conductivity of the thin film electrolyte 18 is between about 10⁻⁶ and about 10⁻¹³ S/cm. In a seventh embodiment of the thin film electrolyte 18, the ionic conductivity of the thin film electrolyte 18 is between about 10⁻⁷ and about 10⁻¹¹ S/cm.

In one embodiment of the thin film electrolyte 18, the thin film electrolyte 18 is a solid state Lithium ion conductor. In one embodiment of the thin film electrolyte 18, the thin film electrolyte 18 includes ionic liquid electrolyte for a Lithium ion battery (LISICON). In one embodiment of the LISICON, the LISICON includes Li₁₄ZnGe₄O₁₆. In one embodiment of the thin film electrolyte 18, the thin film electrolyte 18 is a Sulfide-based Lithium ion conductor. In one embodiment of the Sulfide-based Lithium ion conductor, the Sulfide-based Lithium ion conductor includes Li_{3.25}Ge_{0.25}P_{0.75}S₄. In one embodiment of the Sulfide-based Lithium ion conductor, the Sulfide-based Lithium ion conductor includes Li₃PO₄-63Li₂S-35SiS₂. In one embodiment of the Sulfide-based Lithium ion conductor, the Sulfide-based Lithium ion conductor includes 70Li₂S-30P₂S₅. In one embodiment of the Sulfide-based Lithium ion conductor, the Sulfide-based Lithium ion conductor includes Li₇P₃S₁₁. In one embodiment of the Sulfide-based Lithium ion conductor, the Sulfide-based Lithium ion conductor includes 37Li₂S-45LiI-18P₂S₅. In one embodiment of the Sulfide-based Lithium ion conductor, the Sulfide-based Lithium ion conductor includes 50Li₂S-50GeS₂. In one embodiment of the Sulfide-based Lithium ion conductor, the Sulfide-based Lithium ion conductor includes Thio-LISICON. In one embodiment of the Thio-LISICON, the Thio-LISICON includes Li_{3.4}Si_{0.4}P_{0.6}S₄.

In one embodiment of the thin film electrolyte 18, the thin film electrolyte 18 includes Sulfide glass. In one embodiment of the Sulfide-based Lithium ion conductor, the Sulfide-based Lithium ion conductor includes the Sulfide glass. In one embodiment of the Sulfide glass, the Sulfide glass includes GeS₂+Li₂S+LiI+Ga₂S₃+La₂S₃. In one embodiment of the Sulfide glass, the Sulfide glass includes 0.28SiS₂-0.42Li₂S-0.30LiI. In one embodiment of the Sulfide glass, the Sulfide glass includes 0.20SiS₂-0.13P₂S5-0.67LiI. In one embodiment of the Sulfide glass, the Sulfide glass includes 0.14SiS₂-0.09P₂S₅-0.47Li₂S-0.30LiI. In one embodiment of the Sulfide glass, the Sulfide glass includes 0.27SiS₂-0.03Al₂S₃-0.30Li₂S-0.400LiI. In one embodiment of the Sulfide glass, the Sulfide glass includes 0.21SiS₂-0.09B₂S₃-0.30Li₂S-0.40LiI.

In one embodiment of the thin film electrolyte 18, the thin film electrolyte 18 is an Oxide-based Lithium ion conductor. In one embodiment of the Oxide-based Lithium ion conductor, the Oxide-based Lithium ion conductor includes 63Li₂O-37B₂O₃. In one embodiment of the Oxide-based Lithium ion conductor, the Oxide-based Lithium ion conductor includes 31.8Li₂O-12.3LiCl-59.9B₂O₃. In one embodiment of the Oxide-based Lithium ion conductor, the Oxide-based Lithium ion conductor includes 22.1Li₂O-12.6LiF-15.8Li₂SO₄-20.5Li₂SO₃-28.5B₂O₃. In one embodiment of the Oxide-based Lithium ion conductor, the Oxide-based Lithium ion conductor includes Li₂O—B₂O₃—SiO₂. In one embodiment of the Oxide-based Lithium ion conductor, the Oxide-based Lithium ion conductor includes 71.5Li₂Si₂O₅-28.5Li₂SO₄. In one embodiment of the Oxide-based Lithium ion conductor, the Oxide-based Lithium ion conductor includes 60LiPO₃-40LiF. In one embodiment of the Oxide-based Lithium ion conductor, the Oxide-based Lithium ion conductor includes 70LiPO₃-30LiCl. In one embodiment of the Oxide-based Lithium ion conductor, the Oxide-based Lithium ion conductor includes 67LiPO₃-33LiBr. In one embodiment of the Oxide-based Lithium ion conductor, the Oxide-based Lithium ion conductor includes 67LiPO₃-33Li₂SO₄. In one embodiment of the Oxide-based Lithium ion conductor, the Oxide-based Lithium ion conductor includes 30Li₂O-50LiF-20Al(PO₃)₃. In one embodiment of the Oxide-based Lithium ion conductor, the Oxide-based Lithium ion conductor includes 50Li₂O-50Nb₂O₅. In one embodiment of the Oxide-based Lithium ion conductor, the Oxide-based Lithium ion conductor includes 50Li₂O-50Ta₂O₅.

In one embodiment of the thin film electrolyte 18, the thin film electrolyte 18 is a Sodium ion conductor. In one embodiment of the Sodium ion conductor, the Sodium ion conductor includes Na₃PS₄. In one embodiment of the Sodium ion conductor, the Sodium ion conductor includes β-Al₂O₃ (NaAl₁₁O₁₇). In one embodiment of the β-Al₂O₃ (NaAl₁₁O₁₇), the β-Al₂O₃ (NaAl₁₁O₁₇) includes β-Al₂O₃. In an alternate embodiment of the β-Al₂O₃ (NaAl₁₁O₁₇), the β-Al₂O₃ (NaAl₁₁O₁₇) includes β″-Al₂O₃. In one embodiment of the Sodium ion conductor, the Sodium ion conductor includes Na₅MSi₄O₁₂, where M is a metal.

In one embodiment of the Na₅MSi₄O₁₂, the Na₅MSi₄O₁₂ includes Na₅FeSi₄O₁₂. In one embodiment of the Na₅MSi₄O₁₂, the Na₅MSi₄O₁₂ includes Na₅ScSi₄O₁₂. In one embodiment of the Na₅MSi₄O₁₂, the Na₅MSi₄O₁₂ includes Na₅LuSi₄O₁₂. In one embodiment of the Na₅MSi₄O₁₂, the Na₅MSi₄O₁₂ includes Na₅YbSi₄O₁₂. In one embodiment of the Na₅MSi₄O₁₂, the Na₅MSi₄O₁₂ includes Na₅TmSi₄O₁₂. In one embodiment of the Na₅MSi₄O₁₂, the Na₅MSi₄O₁₂ includes Na₅ErSi₄O₁₂. In one embodiment of the Na₅MSi₄O₁₂, the Na₅MSi₄O₁₂ includes Na₅YSi₄O₁₂. In one embodiment of the Na₅MSi₄O₁₂, the Na₅MSi₄O₁₂ includes Na₅HoSi₄O₁₂. In one embodiment of the Na₅MSi₄O₁₂, the Na₅MSi₄O₁₂ includes Na₅DySi₄O₁₂.

In one embodiment of the Na₅MSi₄O₁₂, the Na₅MSi₄O₁₂ includes Na₅GdSi₄O₁₂. In one embodiment of the Na₅MSi₄O₁₂, the Na₅MSi₄O₁₂ includes Na₅TbSi₄O₁₂. In one embodiment of the Na₅MSi₄O₁₂, the Na₅MSi₄O₁₂ includes Na₅SmSi₄O₁₂. In one embodiment of the Na₅MSi₄O₁₂, the Na₅MSi₄O₁₂ includes NaGd_{0.8}La_{0.2}Si₄O₁₂. In one embodiment of the Na₅MSi₄O₁₂, the Na₅MSi₄O₁₂ includes NaGd_{0.6}Nd_{0.4}Si₄O₁₂. In one embodiment of the Na₅MSi₄O₁₂, the Na₅MSi₄O₁₂ includes NaGd_{0.6}Fr_{0.4}Si₄O₁₂. In one embodiment of the Na₅MSi₄O₁₂, the Na₅MSi₄O₁₂ includes Na_{4.9}Y_{0.9}Zr_{0.1}Si₄O₁₂. In one embodiment of the Na₅MSi₄O₁₂, the Na₅MSi₄O₁₂ includes Na_{4.9}Y_{0.9}Hf_{0.1}Si₄O₁₂.

In one embodiment of the Na₅MSi₄O₁₂, the Na₅MSi₄O₁₂ includes Na_{4.9}Gd_{0.9}Zr_{0.1}Si₄O₁₂. In one embodiment of the Na₅MSi₄O₁₂, the Na₅MSi₄O₁₂ includes Na_{4.9}Dy_{0.9}Zr_{0.1}Si₄O₁₂. In one embodiment of the Na₅MSi₄O₁₂, the Na₅MSi₄O₁₂ includes Na₅TmGeO₁₂. In one embodiment of the Na₅MSi₄O₁₂, the Na₅MSi₄O₁₂ includes Na₅HoGeO₁₂. In one embodiment of the Na₅MSi₄O₁₂, the Na₅MSi₄O₁₂ includes Na₅DyGeO₁₂. In one embodiment of the Na₅MSi₄O₁₂, the Na₅MSi₄O₁₂ includes Na₅TbGeO₁₂. In one embodiment of the Na₅MSi₄O₁₂, the Na₅MSi₄O₁₂ includes Na₅GdSi_{3.75}Ge_{0.25}O_{0.2}. In one embodiment of the Na₅MSi₄O₁₂, the Na₅MSi₄O₁₂ includes Na₅GdSi₃GeO₁₂.

In one embodiment of the thin film electrolyte 18, the thin film electrolyte 18 includes Lithium phosphorus oxynitride (LiPON). In one embodiment of the LiPON, the LiPON includes Li_{2.88}PO_{3.73}N_{0.14}. In one embodiment of the thin film electrolyte 18, the thin film electrolyte 18 includes Lithium aluminum oxide (LAO). In one embodiment of the LAO, the LAO includes Li_{0.13}A_{1.00}O_{1.69}Ar_{0.04}. In an alternate embodiment of the LAO, the LAO includes Li_{0.13}Al_{1.00}O_{1.67}Ar_{0.18}.

In one embodiment of the thin film electrolyte 18, the thin film electrolyte 18 includes Lithium silicon oxide (LSO). In one embodiment of the LSO, the LSO includes Li₂O—SiO₂ (40-60 m/o). In another embodiment of the LSO, the LSO includes Li₂O—SiO₂ (33.3-66.7 m/o). In an alternate embodiment of the LSO, the LSO includes Li₂SiO₃. In an additional embodiment of the LSO, the LSO includes 2Li₂O-3SiO₂. In an additional embodiment of the LSO, the LSO includes 40Li₂O-60SiO₂. In a further embodiment of the LSO, the LSO includes Li₂Si₂O₅. In one embodiment of the thin film electrolyte 18, the thin film electrolyte 18 includes Lithium aluminum silicon oxide (LASO). In a first embodiment of the LASO, the LASO includes Li_{4.4}Si_{0.6}Al_{0.4}O₄. In a second embodiment of the LASO, the LASO includes Li_{4.6}Al_{0.6}Si_{0.4}O₄. In a third embodiment of the LASO, the LASO includes Li₂O—Al₂O₃-2SiO₂ (Stoichiometric). In a fourth embodiment of the LASO, the LASO includes Li₂O—Al₂O₃-1.3SiO₂. In a fifth embodiment of the LASO, the LASO includes 1.3Li₂O—Al₂O₃-2SiO₂. In a sixth embodiment of the LASO, the LASO includes 3.1Li₂O—Al₂O₃-3.8SiO₂. In a seventh embodiment of the LASO, the LASO includes 4.3Li₂O—Al₂O₃-7SiO₂. In an eighth embodiment of the LASO, the LASO includes LiAlSiO₄ Thin Film.

In one embodiment of the thin film electrolyte 18, the thin film electrolyte 18 includes Lithium lanthanum titanium oxide (LLTO). In one embodiment of the LLTO, the LLTO includes Li₃xLa_{(2/3)-}x□_{(1/3)-2}xTiO₃. In one embodiment of the thin film electrolyte 18, the thin film electrolyte 18 includes Lithium aluminum titanium phosphate (LATP). In one embodiment of the LATP, the LATP includes Li_{1.3}Al_{0.3}Ti_{1.7}(PO₄)₃. In one embodiment of the thin film electrolyte 18, the thin film electrolyte 18 includes Garnet. In one embodiment of the Garnet, the Garnet includes Li₆La₂BaTa₂O₁₂. In one embodiment of the thin film electrolyte 18, the thin film electrolyte 18 includes Li ion conductor-mesoporous oxide. In one embodiment of the Li ion conductor-mesoporous oxide, the Li ion conductor-mesoporous oxide includes LiI—Al₂O₃.

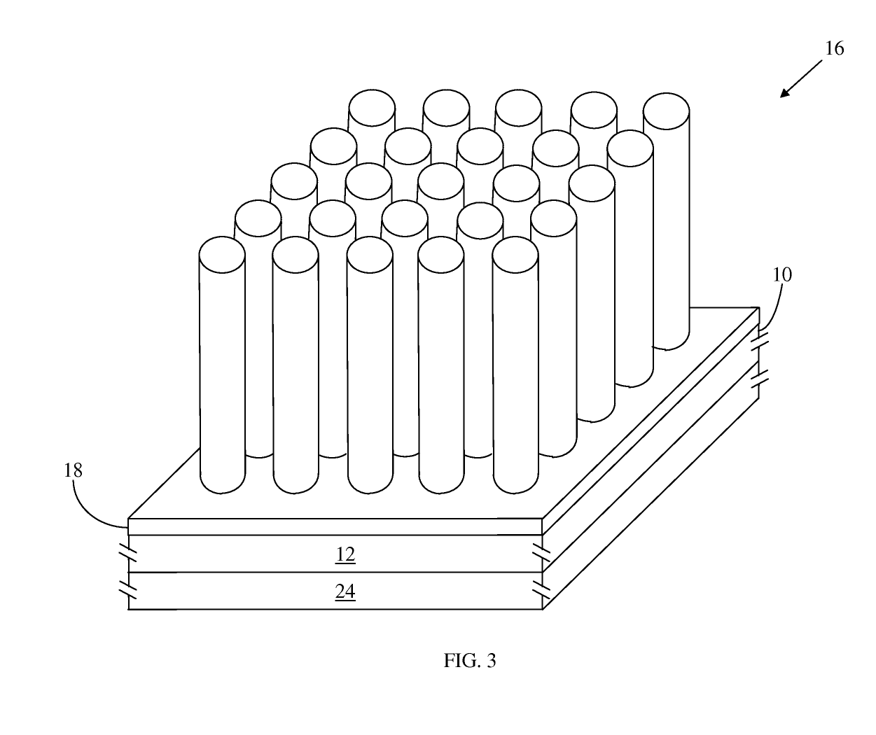

FIG. 3 shows details of the 3D micro-battery structure 16 according to an alternate embodiment of the 3D micro-battery structure 16. The 3D micro-battery structure 16 illustrated in FIG. 3 is similar to the 3D micro-battery structure 16 illustrated in FIG. 2, except the 3D micro-battery structure 16 illustrated in FIG. 3 further includes an electrode current collector 24, which is attached to a surface of the base 12. The electrode current collector 24 provides an electrical connection to the 3D electrode micro-structure 10. In general, the electrode current collector 24 is electrically coupled to the base 12. In another embodiment of the 3D micro-battery structure 16, the electrode current collector 24 is omitted. As such, the base 12 is an electrode current collector. In one embodiment of the electrode current collector 24, the electrode current collector 24 is metallic. In one embodiment of the electrode current collector 24, the electrode current collector 24 includes Copper. In an alternate embodiment of the electrode current collector 24, the electrode current collector 24 includes Aluminum.

FIG. 4 shows details of the 3D micro-battery structure 16 according to an additional embodiment of the 3D micro-battery structure 16. The 3D micro-battery structure 16 illustrated in FIG. 4 is similar to the 3D micro-battery structure 16 illustrated in FIG. 3, except the 3D micro-battery structure 16 illustrated in FIG. 4 further includes the counter electrode micro-structure 26, which substantially fills the spaces 22 (FIG. 2) and is in contact with the group 20 (FIG. 2) of coated electrodes. Due to the spaces 22 (FIG. 2), which are substantially filled, the group 20 (FIG. 2) of coated electrodes may collectively have a large surface area to readily facilitate ion conduction between the group 20 (FIG. 2) of coated electrodes and the counter electrode micro-structure 26.

In an alternate embodiment of the 3D micro-battery structure 16, the counter electrode micro-structure 26 is replaced with a liquid counter electrode material, which substantially fills the spaces 22 (FIG. 2) and is in contact with the group 20 (FIG. 2) of coated electrodes. In one embodiment of the 3D micro-battery structure 16, the 3D electrode micro-structure 10 functions as an anode and the counter electrode micro-structure 26 functions as a cathode. In an alternate embodiment of the 3D micro-battery structure 16, the 3D electrode micro-structure 10 functions as a cathode and the counter electrode micro-structure 26 functions as an anode.

In a first embodiment of the counter electrode micro-structure 26, the counter electrode micro-structure 26 includes Carbon. In a second embodiment of the counter electrode micro-structure 26, the counter electrode micro-structure 26 includes Silicon. In a third embodiment of the counter electrode micro-structure 26, the counter electrode micro-structure 26 includes Tin. In a fourth embodiment of the counter electrode micro-structure 26, the counter electrode micro-structure 26 includes Lithium. In a fifth embodiment of the counter electrode micro-structure 26, the counter electrode micro-structure 26 includes Titanium.

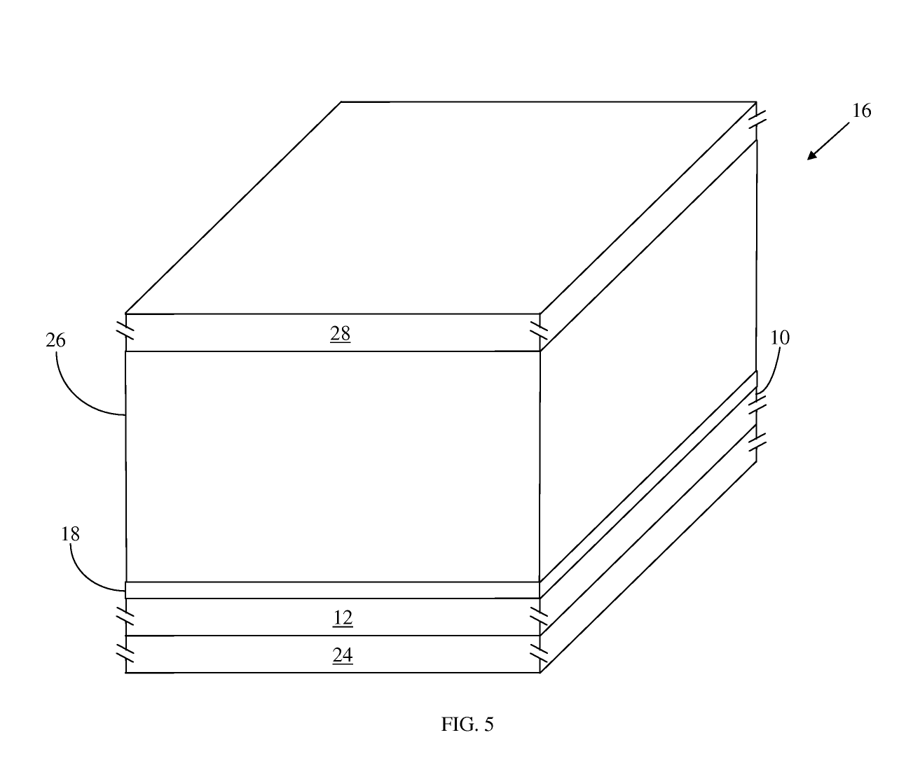

FIG. 5 shows details of the 3D micro-battery structure 16 according to another embodiment of the 3D micro-battery structure 16. The 3D micro-battery structure 16 illustrated in FIG. 5 is similar to the 3D micro-battery structure 16 illustrated in FIG. 4, except the 3D micro-battery structure 16 illustrated in FIG. 5 further includes a counter electrode current collector 28, which is attached to the counter electrode micro-structure 26. The counter electrode current collector 28 provides an electrical connection to the counter electrode micro-structure 26. In general, the counter electrode current collector 28 is electrically coupled to the counter electrode micro-structure 26. In one embodiment of the counter electrode current collector 28, the counter electrode current collector 28 is metallic. In one embodiment of the counter electrode current collector 28, the counter electrode current collector 28 includes Copper. In an alternate embodiment of the counter electrode current collector 28, the counter electrode current collector 28 includes Aluminum. In one embodiment of the 3D micro-battery structure 16, the 3D micro-battery structure 16 is a 3D micro-battery.

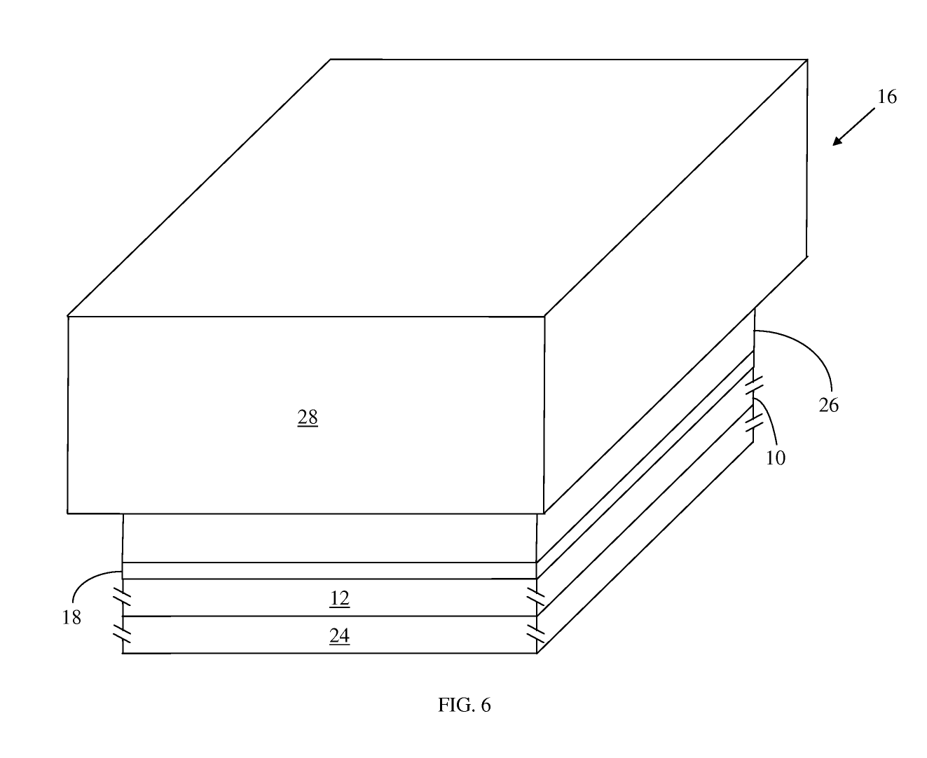

FIG. 6 shows details of the 3D micro-battery structure 16 according to a further embodiment of the 3D micro-battery structure 16. The 3D micro-battery structure 16 illustrated in FIG. 6 is similar to the 3D micro-battery structure 16 illustrated in FIG. 5, except in the 3D micro-battery structure 16 illustrated in FIG. 6, the counter electrode current collector 28 is attached to a larger surface area of the counter electrode micro-structure 26 than the counter electrode current collector 28 illustrated in FIG. 5. As such, the internal battery resistance of the 3D micro-battery structure 16 may be reduced.

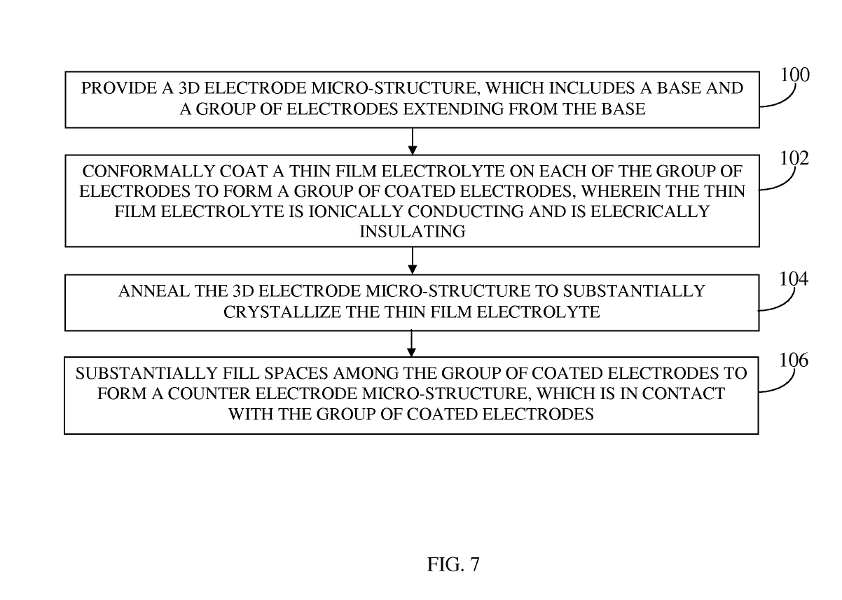

FIG. 7 illustrates a process for forming the 3D micro-battery structure 16 illustrated in FIG. 2 according to one embodiment of the 3D micro-battery structure 16. The process begins by providing the 3D electrode micro-structure 10, which includes the base 12 and the group 14 of electrodes extending from the base 12 (Step 100). The process proceeds by conformally coating the thin film electrolyte 18 on each of the group 14 of electrodes to form the group 20 of coated electrodes, wherein the thin film electrolyte 18 is ionically conducting and is electrically insulating (Step 102). The process proceeds by annealing the 3D electrode micro-structure 10 to substantially crystallize the thin film electrolyte 18 (Step 104). The process concludes by substantially filling the spaces 22 among the group 20 of coated electrodes to form the counter electrode micro-structure 26 (FIG. 4), which is in contact with the group 20 of coated electrodes (Step 106).

In an alternate process for forming the 3D micro-battery structure 16 illustrated in FIG. 2, the process step of substantially filling the spaces 22 among the group 20 of coated electrodes to form the counter electrode micro-structure 26 (FIG. 4), which is in contact with the group 20 of coated electrodes (Step 106) is omitted. In an additional process for forming the 3D micro-battery structure 16 illustrated in FIG. 2, the process step of annealing the 3D electrode micro-structure 10 to substantially crystallize the thin film electrolyte 18 (Step 104) is omitted. In another process for forming the 3D micro-battery structure 16 illustrated in FIG. 2, the process step of substantially filling the spaces 22 among the group 20 of coated electrodes to form the counter electrode micro-structure 26 (FIG. 4), which is in contact with the group 20 of coated electrodes (Step 106) and the process step of annealing the 3D electrode micro-structure 10 to substantially crystallize the thin film electrolyte 18 (Step 104) are both omitted.

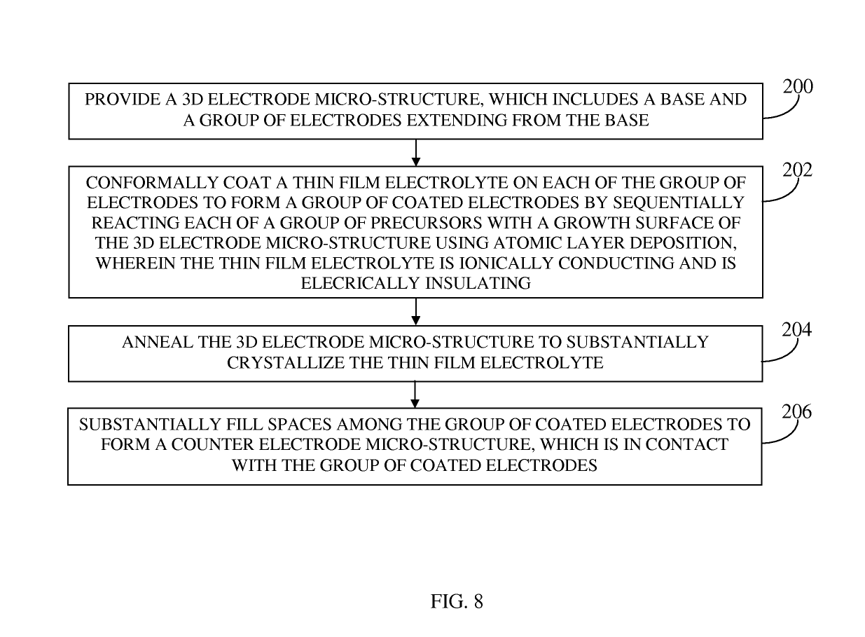

Atomic layer deposition (ALD) is a thin film deposition technique based on sequentially reacting each of a group of precursors with a growth surface to produce a thin film. Each sequential reaction is called a pulse. In one embodiment of the process to form the 3D micro-battery structure 16 (FIG. 2) illustrated in FIG. 8, ALD is employed to grow the thin film electrolyte 18 (FIG. 2) due to its ability of providing conformal coatings and elimination of pinholes while maintaining thickness uniformity and homogeneity of the deposited thin film, which may not be demonstrated by other thin film deposition techniques. By using ALD, the thin film electrolyte 18 (FIG. 2) is a conformal solid state ionic conductor (SSIC) thin film. Using the SSIC thin film as the thin film electrolyte 18 (FIG. 2) may provide certain advantages, such as high reliability, resistance to shocks and vibrations, protection of electrode materials, ionic conduction, and electrical insulation.

FIG. 8 illustrates a process for forming the 3D micro-battery structure 16 illustrated in FIG. 2 according to one embodiment of the 3D micro-battery structure 16. The process begins by providing the 3D electrode micro-structure 10, which includes the base 12 and the group 14 of electrodes extending from the base 12 (Step 200). The process proceeds by conformally coating the thin film electrolyte 18 on each of the group 14 of electrodes to form the group 20 of coated electrodes by sequentially reacting each of a group of precursors with a growth surface of the 3D electrode micro-structure 10 using atomic layer deposition, wherein the thin film electrolyte 18 is ionically conducting and is electrically insulating (Step 202). The process proceeds by annealing the 3D electrode micro-structure 10 to substantially crystallize the thin film electrolyte 18 (Step 204). The process concludes by substantially filling the spaces 22 among the group 20 of coated electrodes to form the counter electrode micro-structure 26 (FIG. 4), which is in contact with the group 20 of coated electrodes (Step 206). In one embodiment of the process for forming the 3D micro-battery structure 16 illustrated in FIG. 2, the thin film electrolyte 18 includes Lithium aluminosilicate, a first of the group of precursors includes Tetraethyl orthosilicate, a second of the group of precursors includes Trimethylaluminum, and a third of the group of precursors includes Lithium t-butoxide. Using Tetraethyl orthosilicate deposits a layer of Silicon dioxide on the growth surface. Using Trimethylaluminum deposits a layer of Aluminum oxide on the growth surface. Using Lithium t-butoxide deposits a layer of Lithium oxide on the growth surface.

When sequentially reacting each of the group of precursors with the growth surface of the 3D electrode micro-structure 10 using ALD, an ALD deposition chamber is used to conformally coat the thin film electrolyte 18 on each of the group 14 of electrodes. In one embodiment of the deposition process, a temperature inside the ALD deposition chamber is between about 275 degrees Celsius and about 325 degrees Celsius. In an exemplary embodiment of the deposition process, the temperature inside the ALD deposition chamber is equal to about 300 degrees Celsius. In one embodiment of the deposition process, a pressure inside the ALD deposition chamber is between about 3×10⁻³ Torr and about 3×10⁻² Torr. In an exemplary embodiment of the deposition process, the pressure inside the ALD deposition chamber is equal to about 10⁻² Torr. In one embodiment of the deposition process, an oxidant is used to facilitate layer growth. In one embodiment of the deposition process, the oxidant includes water.

During each reaction cycle in which one of the group of precursors is reacted with the growth surface of the 3D electrode micro-structure 10, a layer is deposited on the growth surface. In one embodiment of the deposition process, a thickness of each deposited layer is between about 0.5 Angstroms and about 5 Angstroms per cycle. In an exemplary embodiment of the deposition process, the thickness of each deposited layer is between about 0.8 Angstroms and about 2 Angstroms per cycle. Sequentially depositing all of the group of precursors completes one full cycle. In one embodiment of the deposition process, a combined thickness of the deposited layers is between about 1 Angstrom and about 10 Angstroms per full cycle. In an exemplary embodiment of the deposition process, the combined thickness of the deposited layers is between about 4.5 Angstroms and about 5.5 Angstroms per full cycle.

In one embodiment of annealing the 3D electrode micro-structure 10, the 3D electrode micro-structure 10 is heated to between about 700 degrees Celsius and about 1100 degrees Celsius. In an alternate embodiment of annealing the 3D electrode micro-structure 10, the 3D electrode micro-structure 10 is heated to between about 800 degrees Celsius and about 1000 degrees Celsius. In an exemplary embodiment of annealing the 3D electrode micro-structure 10, the 3D electrode micro-structure 10 is heated to about 900 degrees Celsius.

In an alternate process for forming the 3D micro-battery structure 16 illustrated in FIG. 2, the process step of substantially filling the spaces 22 among the group 20 of coated electrodes to form the counter electrode micro-structure 26 (FIG. 4), which is in contact with the group 20 of coated electrodes (Step 206) is omitted. In an additional process for forming the 3D micro-battery structure 16 illustrated in FIG. 2, the process step of annealing the 3D electrode micro-structure 10 to substantially crystallize the thin film electrolyte 18 (Step 204) is omitted. In another process for forming the 3D micro-battery structure 16 illustrated in FIG. 2, the process step of substantially filling the spaces 22 among the group 20 of coated electrodes to form the counter electrode micro-structure 26 (FIG. 4), which is in contact with the group 20 of coated electrodes (Step 206) and the process step of annealing the 3D electrode micro-structure 10 to substantially crystallize the thin film electrolyte 18 (Step 204) are both omitted.

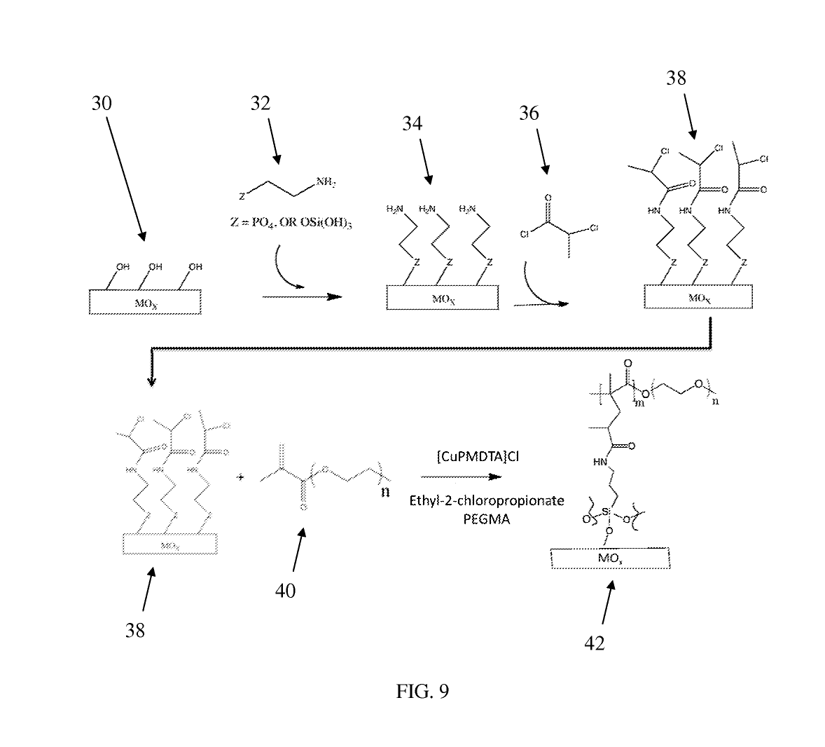

FIG. 9 illustrates surface grafting a conformal thin film polymer electrolyte on a surface of the group 14 (FIG. 1) of electrodes according to one embodiment of the present disclosure. Each of the group 14 of electrodes (FIG. 1) has a corresponding metal oxide surface 30 from which polymer chains may be directly grown. As such, the thin film electrolyte 18 (FIG. 2), which is the conformal thin film polymer electrolyte, is grown directly from each corresponding metal oxide surface 30. A surface treatment agent 32 is applied to the metal oxide surface 30 to prepare the metal oxide surface 30 for polymer growth. In one embodiment of the surface treatment agent 32, the surface treatment agent 32 functions as a polymerization initiator. In an alternate embodiment of the surface treatment agent 32, the surface treatment agent 32 contains a functional group, which is then chemically modified to become the polymerization initiator.

The polymerization initiator functionalizes the metal oxide surface 30 to form a functionalized surface 34. The polymerization initiator is activated in the presence of a selected monomer unit 36, thereby forming a monolayer 38 of a polymer electrolyte, which is covalently linked to the functionalized surface 34 via the polymerization initiator. In one embodiment of the surface treatment agent 32, the surface treatment agent 32 includes an alkyl. In an alternate embodiment of the surface treatment agent 32, the surface treatment agent 32 includes alkoxy silane. In another embodiment of the surface treatment agent 32, the surface treatment agent 32 includes a phosphoric acid.

The technique described above is amenable to a large variety of different selected monomer units 36. Further, many different types of surface grafted polymer electrolytes can be synthesized. Polymer electrolytes containing polyethylene oxide (PEO) units can be synthesized using Atom Transfer Radical Polymerization (ATRP) by using a proper surface initiator group, using a selected monomer unit 36 containing a PEO chain, and using a metal catalyst. Examples of a proper surface initiator group include α-chloroamides, α-chloroesters, α-chlorobenzyl derivatives, the like, or any combination thereof. Suitable selected monomer units 36 for the synthesis of surface grafted polymer electrolytes include: PEO substituted acrylates, methacrylates, and styrenes. The catalyst is formed in situ from a Cu(I) salt and a N″,N″,N′,N,N-pentamethyldiethylenetriamine ligand, or phenanthroline or bipyridine derivatives. This method is also amenable to other living polymerization techniques as well such as Radical Atom Transfer Polymerization (RAFT) and Ring Opening Metathesis Polymerization (ROMP). Polyelectrolyte films can also be grafted from surfaces using this method by using an appropriate selected monomer unit 36 such as Lithium 4-vinyltrifluoromethylsulfonylimide.

The bottom of FIG. 9 illustrates a procedure for the creation of a surface grafted poly(poly(ethylene glycol)methacrylate) polyPEGMA polymer thin film electrolyte, which is used as the thin film electrolyte 18 (FIG. 2) in one embodiment of the thin film electrolyte 18 (FIG. 2). PolyPEGMA thin films 42 are surface grafted from a monolayer 38 of an α-chloro amide atom transfer radical polymerization (ATRP)^{|} initiator. The monolayer 38 is created by functionalizing the metal oxide surface 30 with a dense layer of 3-aminopropyltriethoxy silane, and then reacting the amino functionalized monolayer 38 with 2-chloropropionyl chloride to form the α-chloroamide. The PolyPEGMA thin films 42 are then grafted from the functionalized monolayer 38 using a Cu(I) catalyzed ATRP polymerization of a PEGMA monomer 40. Upon completion of the polymerization, the films are then soaked in a solution of 1 mM lithium bistrifluoromethanesulfonimide in MeCN, and the excess liquid is removed by spin coating at 2000 rpms.

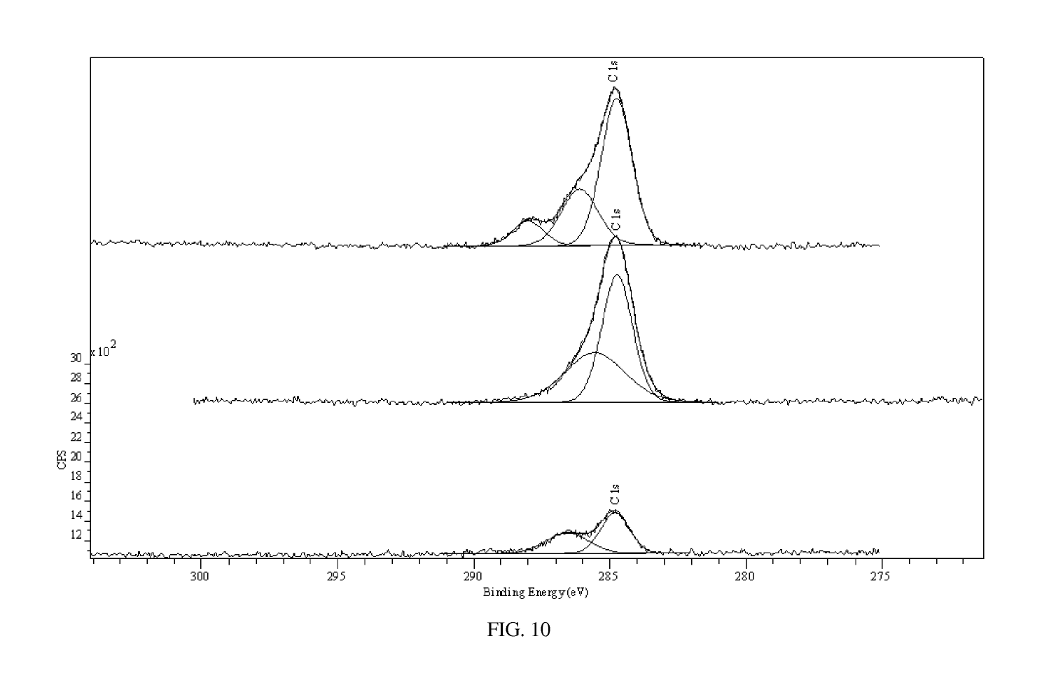

X-ray photoelectron spectroscopy (XPS) shows sequential formation of the α-chloroamide functionalized monolayer with the expected 1:1 ratio of nitrogen to chlorine in the final monolayer as illustrated in FIGS. 10, 11, and 12. The average number molecular weight of the polyPEGMA thin film 42 is 35,000 g/mol (n_{avg}˜75) with a polydispersity index of 1.7 by gel permeation chromatography (using PEO standard). Profilometry measurements show an average film thickness of 30±20 nm, which suggests a relatively low grating density considering the large molecular weight of the polymer. Calculated ionic conductivity of the films is 1.3×10⁻⁵ S cm⁻¹, which is a few orders of magnitude lower than the PEGMA monomer 40 and may be appropriate for 3-D battery applications.

FIG. 10 shows three graphs illustrating X-Ray photoelectron spectroscopy Carbon core loss peaks of a Silicon wafer. The bottom trace shows the Silicon wafer with a 2 nanometer native oxide layer. The middle trace shows the Silicon wafer treated with 3-aminopropyltrimethoxysilane. The top trace shows the final, 3-(2-chloropropanamido)-propyl siloxane modified surface initiator.

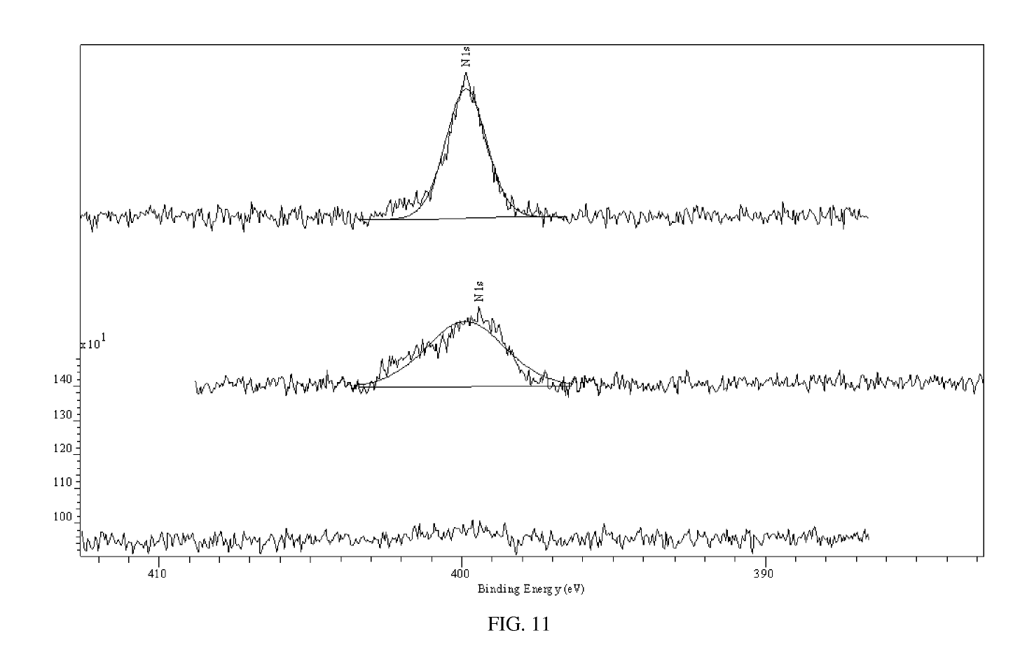

FIG. 11 shows three graphs illustrating X-Ray photoelectron spectroscopy Nitrogen core loss peaks of a Silicon wafer. The bottom trace shows the Silicon wafer with a 2 nanometer native oxide layer. The middle trace shows the Silicon wafer treated with 3-aminopropyltrimethoxysilane. The top trace shows the final, 3-(2-chloropropanamido)-propyl siloxane modified surface initiator.

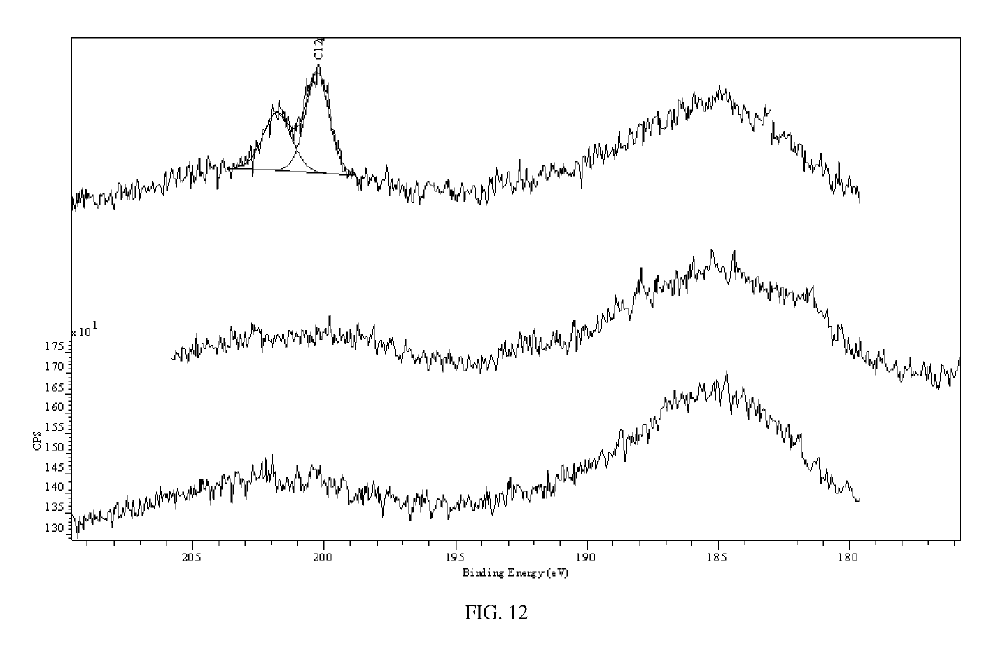

FIG. 12 shows three graphs illustrating X-Ray photoelectron spectroscopy Chlorine core loss peaks of a Silicon wafer. The bottom trace shows the Silicon wafer with a 2 nanometer native oxide layer. The middle trace shows the Silicon wafer treated with 3-aminopropyltrimethoxysilane. The top trace shows the final, 3-(2-chloropropanamido)-propyl siloxane modified surface initiator.

Those skilled in the art will recognize improvements and modifications to the preferred embodiments of the present disclosure. All such improvements and modifications are considered within the scope of the concepts disclosed herein and the claims that follow.

1. A 3D micro-battery structure comprising:
a 3D electrode micro-structure comprising a base and a plurality of electrodes extending from the base; and
a thin film electrolyte conformally coating each of the plurality of electrodes to form a plurality of coated electrodes, wherein the thin film electrolyte is ionically conducting and is electrically insulating.

2. (canceled)

3. The 3D micro-battery structure of claim 1 wherein the thin film electrolyte comprises lithium aluminosilicate.

4. The 3D micro-battery structure of claim 1 wherein the thin film electrolyte is a solid state Lithium ion conductor.

5. The 3D micro-battery structure of claim 1 wherein the thin film electrolyte is an Oxide-based Lithium ion conductor.

6. The 3D micro-battery structure of claim 1 wherein the thin film electrolyte comprises ionic liquid electrolyte for a Lithium ion battery (LISICON).

7. The 3D micro-battery structure of claim 1 wherein the thin film electrolyte is a Sulfide-based Lithium ion conductor.

8. The 3D micro-battery structure of claim 7 wherein the thin film electrolyte comprises Thio-ionic liquid electrolyte for a Lithium ion battery (LISICON).

9. The 3D micro-battery structure of claim 7 wherein the thin film electrolyte comprises Sulfide glass.

10. The 3D micro-battery structure of claim 1 wherein the thin film electrolyte is a Sodium ion conductor.

11. The 3D micro-battery structure of claim 1 wherein the thin film electrolyte comprises Lithium phosphorus oxynitride (LiPON).

12. The 3D micro-battery structure of claim 1 wherein the thin film electrolyte comprises Lithium aluminum oxide (LAO).

13. The 3D micro-battery structure of claim 1 wherein the thin film electrolyte comprises Lithium silicon oxide (LSO).

14. The 3D micro-battery structure of claim 1 wherein the thin film electrolyte comprises Lithium aluminum silicon oxide (LASO).

15. The 3D micro-battery structure of claim 1 wherein the thin film electrolyte comprises organic material.

16. (canceled)

17. (canceled)

18. (canceled)

19. The 3D micro-battery structure of claim 1 wherein there are spaces among the plurality of coated electrodes and further comprising a counter electrode micro-structure substantially filling the spaces and in contact with the plurality of coated electrodes.

20. (canceled)

21. (canceled)

22. (canceled)

23. The 3D micro-battery structure of claim 1 wherein there are spaces among the plurality of coated electrodes and further comprising a liquid counter electrode material substantially filling the spaces and in contact with the plurality of coated electrodes.

24. (canceled)

25. A method for forming a 3D micro-battery structure comprising:
providing a 3D electrode micro-structure comprising a base and a plurality of electrodes extending from the base; and
conformally coating a thin film electrolyte on each of the plurality of electrodes to form a plurality of coated electrodes, wherein the thin film electrolyte is ionically conducting and is electrically insulating.

26. The method for forming the 3D micro-battery structure of claim 25 wherein the conformally coating the thin film electrolyte on each of the plurality of electrodes comprises sequentially reacting each of a plurality of precursors with a growth surface of the 3D electrode micro-structure using atomic layer deposition.

27. The method for forming the 3D micro-battery structure of claim 26 wherein the thin film electrolyte comprises lithium aluminosilicate, a first of the plurality of precursors comprises tetraethyl orthosilicate, a second of the plurality of precursors comprises trimethylaluminum, and a third of the plurality of precursors comprises lithium t-butoxide.

28. The method for forming the 3D micro-battery structure of claim 25 further comprising annealing the 3D electrode micro-structure to substantially crystallize the thin film electrolyte.

29. (canceled)
